(19) United States
(12) Patent Application Publication
(10) Pub. No.: US 2015/0007279 A1
(43) Pub. Date: Jan. 1, 2015

(54) COMMUNICATION METHOD, DEVICE, INFORMATION PROCESSING APPARATUS, AND STORAGE MEDIUM

(71) Applicant: CANON KABUSHIKI KAISHA, Tokyo (JP)

(72) Inventor: Yusuke Hattori, Tokyo (JP)

(21) Appl. No.: 14/308,083

(22) Filed: Jun. 18, 2014

(30) Foreign Application Priority Data
Jun. 27, 2013 (JP) 2013-135013

(51) Int. Cl. H04L 29/06

(52) U.S. Cl. CPC H04L 63/08; H04L 63/0838
USPC 726/5

(57) ABSTRACT

To provide a communication method a device, an image processing apparatus, and a program for performing communication in accordance with different communication methods in communication to acquire an authentication ID to utilize a Web service and in communication to provide the Web service using the authentication ID. The device acquires the authentication ID to utilize the Web service by a Web browser from an authentication server using a first communication method. The device communicates with a Web server that provides the Web service using the authentication ID by the Web browser by a second communication method different from the first communication method.

### BACKGROUND OF THE INVENTION

1. Field of the Invention

The present invention relates to a communication method, a peripheral device, an information processing apparatus, and a storage medium storing a program in a network system that provides a Web service in response to a request from a peripheral device including a Web browser.

2. Description of the Related Art

The development of the computer technique and the network communication technique in recent years is remarkable. The system for controlling an information processing apparatus and its peripheral device by utilizing various interfaces, such as USB, Ethernet (registered trademark), and wireless LAN, is effectively made use of in a variety of scenes, such as home and office. As an example of the peripheral device, mention is made of a mobile phone, a TV, a printer, a copying machine, a facsimile, a scanner, a digital camera, an MFP (Multi Function Peripheral), etc.

At present, various services are provided by utilizing the Internet. The services include a Web service that provides the function and service of a peripheral device to a user via a network by controlling the peripheral device connected by the network by a server device. In order to use a Web service, it is necessary to specify a user to whom the service is provided or a peripheral device that a user uses, and because of this, it is necessary to authenticate and register identification information to specify a peripheral device and the Web service provided by the server device in association with each other.

As the authentication and registration method, such a method is performed in general, in which the server device issues an ID and a password to a user to be registered or a peripheral device a user uses by the procedure as below.
1) HTTP communication to the server device is established using a Web browser included in the peripheral device.
2) The server device returns a registration information input form including ID and password entry fields by an HTTP response.
3) The user inputs necessary information to the registration information input form using the Web browser of the peripheral device and makes an HTTP request.
4) The server device registers the ID and password to specify the user or the peripheral device the user uses to a database.

As the method for performing the above-described authentication and registration processing with a high level of security and usability, the method has been proposed in which a port dedicated to registration is provided, the MAC address of peripheral equipment is received from the registration dedicated port, and the MAC address is stored in the database (Japanese Patent Laid-Open No. 2000-252993).

Further, the method has also been proposed in which upon receipt of a request for registration from a peripheral device, the server device generates new identification information and a key code and stores them in association with each other, and generates a Web page for individual authentication dedicated to the peripheral device, and the peripheral device stores the Web page (Japanese Patent Laid-Open No. 2002-366516).

However, according to Japanese Patent Laid-Open No. 2000-252993, it is necessary to provide a special port and there is a possibility that at the time of change of the Web service provided by the server device, it also becomes necessary for the peripheral device to make a change accordingly.

Further, according to the technique of Japanese Patent Laid-Open No. 2002-366516, a problem of identity fraud of the peripheral device, i.e., such a problem may occur that the address information of the server device is leaked by illegal acquisition etc. to a user without right and a request for registration is made an infinite number of times by the peripheral device to the server device.

The present invention has been made in view of the above-described problems and an object of the present invention is to provide a communication method for performing communication in accordance with different communication methods in communication for acquiring an authentication ID to utilize a Web service and in communication for providing the Web service using the authentication ID, a device, an information processing apparatus, and a program.

### SUMMARY OF THE INVENTION

The communication method according to the present invention is a communication method between a device including a Web browser and a server, the method including the steps of: acquiring, by the device, an authentication ID to utilize a Web service by the Web browser by a first communication method that does not use the Web browser; and communicating, by the device, with the Web server that provides the Web service using the authentication ID acquired in the acquisition step by a second communication method that uses the Web browser.

According to the present invention, it is possible to establish communication in accordance with different communication methods in communication for acquiring an authentication ID to utilize a Web service and in communication for providing the Web service using the authentication ID.

Further features of the present invention will become apparent from the following description of exemplary embodiments (with reference to the attached drawings).

### BRIEF DESCRIPTION OF THE DRAWINGS

FIG. 1 is a block diagram showing an example of a configuration of a client-server network system according to a first embodiment;

FIG. 2 is a block diagram showing an outline of a configuration of an MFP;

FIG. 3 is a block diagram showing an outline of a configuration of a client device and a server device;

FIG. 4 is a diagram showing an example of a menu screen;

FIG. 5 is a flowchart showing a flow of activation processing of a Web browser;

FIG. 6 is a sequence chart showing details of authentication ID acquisition processing;

FIG. 7 is a diagram showing an example of communication data at the time of making a request for registration;

FIG. 8 is a flowchart showing a flow of processing in a Web server;

FIG. 9 is a sequence chart showing details from the time of making a request for a Web service from the MFP until a state where the Web service is available is brought about;

FIG. 10 is a diagram showing an example of a Web service registration screen;

FIG. 11 is a diagram showing an example of communication data at the time of making a request for a Web service home screen;

FIG. 12 is a diagram showing an example of a Web service home screen provided by the Web server;

FIG. 13 is a block diagram showing an outline of a configuration of a client-server network system according to a second embodiment;

FIGS. 14A and 14B are sequence charts showing details from the time of making a request for a Web service from the MFP until a state where the Web service is available is brought about according to the second embodiment; and

FIG. 15 is a diagram showing an example of a Web service selection screen.

### DESCRIPTION OF THE EMBODIMENTS

Hereinafter, with reference to the attached drawings, preferred embodiments of the present invention are explained in detail.

### First Embodiment

First, a configuration of a network system, which is the fundamentals of the present embodiment, is explained.

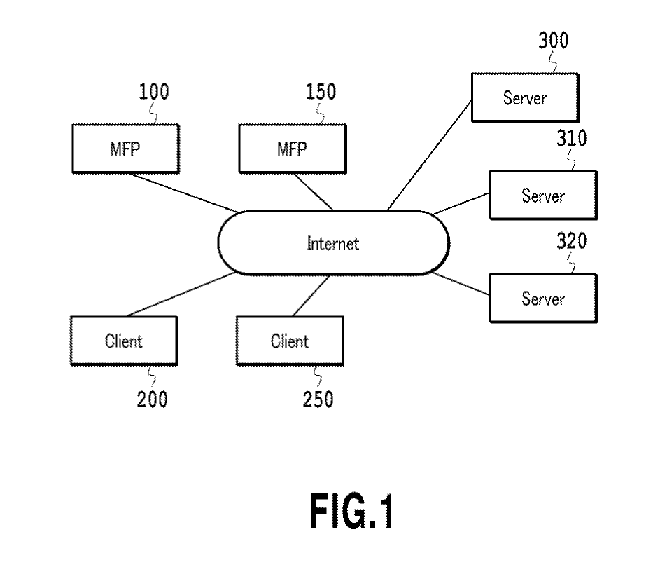

FIG. 1 is a block diagram showing an example of a configuration of a client-server network system according to the present embodiment. The network system shown in FIG. 1 includes two MFPs 100 and 150, two client devices 200 and 250, and three server devices 300, 310, and 320, and the respective components are connected via the Internet. In FIG. 1, it is assumed that the server device 300 is a management server for managing peripheral devices (here, MFP), the server device 310 is an authentication server for performing authentication processing, and the server device 320 is a Web server for providing a Web service in response to a request from a peripheral device. The MFPs 100 and 150, and the clients 200 and 250 communicate with the servers 300 to 320 via the Internet.

A network system for providing a Web service requires one or more server devices, however, the configuration of the network system is not limited to the configuration shown in FIG. 1. For example, it may also be possible to cause one server device to have functions of a plurality of servers, such as the management server and the authentication server. Conversely, it may also be possible to use more server devices and to divide and allocate functions to the server devices for the purpose of dispersing loads etc.

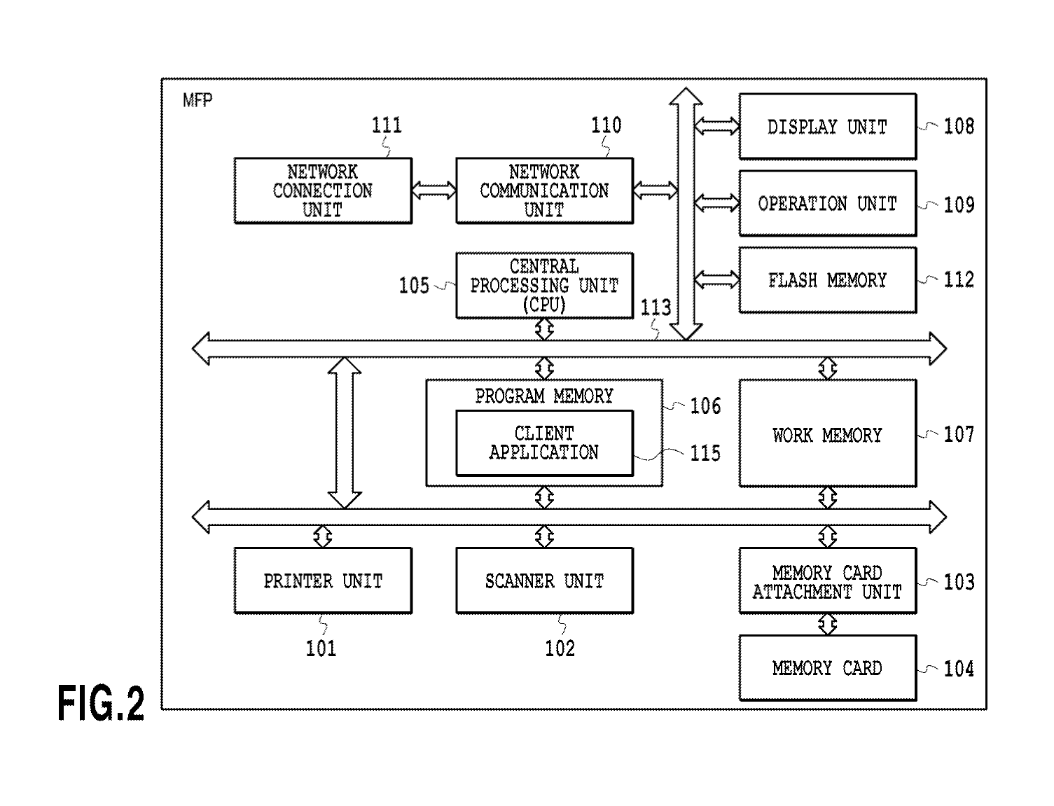

FIG. 2 is a block diagram showing an outline of a configuration of the MFPs 100/150 as peripheral devices. In the present application, the MFP mounting a Web browser is explained mainly as an example of a peripheral device. However, the example is not limited to this and the peripheral device mounting a Web browser may be, for example, a copying machine, a facsimile, a scanner, a digital camera, a mobile phone, a tablet-type PC, etc.

The MFPs 100/150 include a Web browser and capable of performing HTTP communication and HTTPS communication with the server device and of providing the printing function, the scanner function, and the storage function (service) via a network.

In the MFPs 100/150, the printing function is implemented by a printer unit 101, the scanner function by a scanner unit 102, and the storage function by a memory card attachment unit 103 and a memory card 104.

The printer unit 101 prints image data received from outside, image data stored in the memory card 104, etc., on a printing sheet by a recording system, such as an inkjet system and an electrophotographic system.

The scanner unit 102 optically reads a document set on a document table (not shown) and converts it into electronic data, and further, transmits image data, which is the electronic data converted into a specified file format, to an external device via the network or stores the image data in a saving area (not shown), such as an HDD. The copy service is implemented by transferring image data generated by the scanner unit 102 reading a document placed on a document table to the printer unit 101 and by the printer unit 101 printing the image data on a printing sheet.

In the memory card 104 attached to the memory card attachment unit 103, various kinds of file data are stored. It is possible to read the file data from an external device via the network and to edit the file data. Further, it is also possible to store the file data from the external device in the memory card 104.

Further, the MFPs 100/150 include a CPU 105, a program memory 106, a work memory 107, a display unit 108, an operation unit 109, a network communication unit 110, a network connection unit 111, and a flash memory 112.

The CPU 105 is a central processing unit for controlling each unit within the MFPs 100/150.

The program memory 106 includes a ROM etc. and stores various kinds of program codes and a client application 115 to communicate with the server device.

The work memory 107 includes a RAM etc. and temporarily stores or buffers image data at the time of performing each service.

The display unit 108 includes, for example, an LCD and displays various kinds of information. For example, in the case where the client application 115 is used, the display unit 108 displays a built-in UI peculiar to the client application 115 (hereinafter, referred to as a “built-in UI”. In the case where the Web browser is active, the display unit 108 displays the UI of the Web browser (hereinafter, referred to as a “browser UI”).

The built-in UI displays a display screen in accordance with screen information generated by the client application 115. In the case where the operation by a user is performed through the built-in UI, it is possible to communicate with outside by the communication method peculiar to the client application 115. The browser UI corresponds to a general-purpose Web browser and produces a display in accordance with the received Web page. In the case where the operation is performed through the browser UI, communication with outside is established by a general-purpose communication method, such as the HTTP.

The operation unit 109 includes switches etc. with which for a user to perform various kinds of input operations.

There may be a case where the display unit 108 and the operation unit 109 are provided separately or there may be a case where a touch panel as the operation unit 109 is provided on the display unit 108.

The network communication unit 110 connects the MFPs 100/150 to the network and performs various kinds of communication. It is possible to connect to a network, such as the Internet, via the network connection unit 111. The network communication unit 110 is compatible with a wired LAN or a wireless LAN and the network connection unit 111 in the case where the network communication unit 110 is compatible with a wired LAN is a connector for connecting the cable of the wired LAN and the network connection unit 111 in the case where the network communication unit 110 is compatible with a wireless LAN is an antenna.

The flash memory 112 is a nonvolatile memory for storing image data etc. received by the network communication unit 110.

Then, each unit described above is connected to each other via a bus 113.

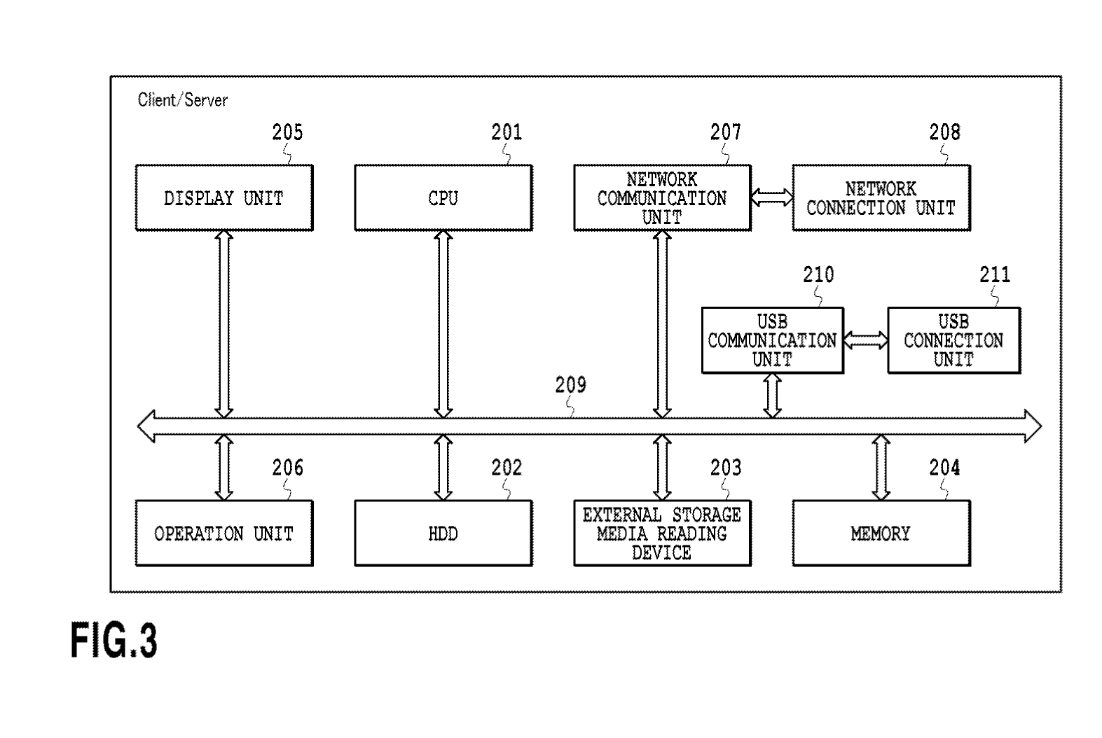

FIG. 3 is a block diagram showing an outline of a configuration of the client devices 200/250 and the server devices 300/310/320 as an information processing apparatus.

A CPU 201 is a central processing unit for controlling each unit below.

An HDD 202 stores various kinds of files, in addition to application programs and OS read by the CPU 201.

An external storage media reading device 203 is a device for reading information, such as a file, stored in an external storage medium, such as an SD card.

A memory 204 includes a RAM etc. and temporarily stores, buffers, etc., data in accordance with the need by the CPU 201.

A display unit 205 includes, for example, an LCD, and displays various kinds of information.

An operation unit 206 includes a keyboard, a mouse, etc., with which for a user to perform the input operation.

As in the case of the MFPs 100/150, there may be a case where the display unit 205 and the operation unit 206 are provided separately, or there may be a case where a touch panel as the operation unit 206 is provided on the display unit 205.

A network communication unit 207 connects the client device and the server device to a network to perform various kinds of communication and is connected with a network, such as the Internet, via a network connection unit 208.

The network communication unit 207 is compatible with a wired LAN or a wireless LAN and the network connection unit 208 in the case where the network communication unit 207 is compatible with a wired LAN is a connector for connecting the cable of a wired LAN and the network connection unit 208 in the case where the network communication unit 207 is compatible with a wireless LAN is an antenna.

A USB communication unit 210 is connected with various kinds of peripheral devices via a USB connection unit 211 and performs various kinds of communication.

Then, each unit described above is connected to each other via a bus 209. Next, processing to register the MFPs 100/150, which are peripheral devices, in order to utilize a Web service in the network system shown in FIG. 1 is explained.

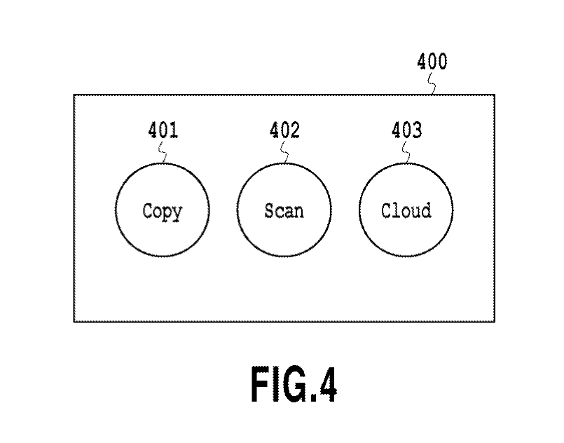

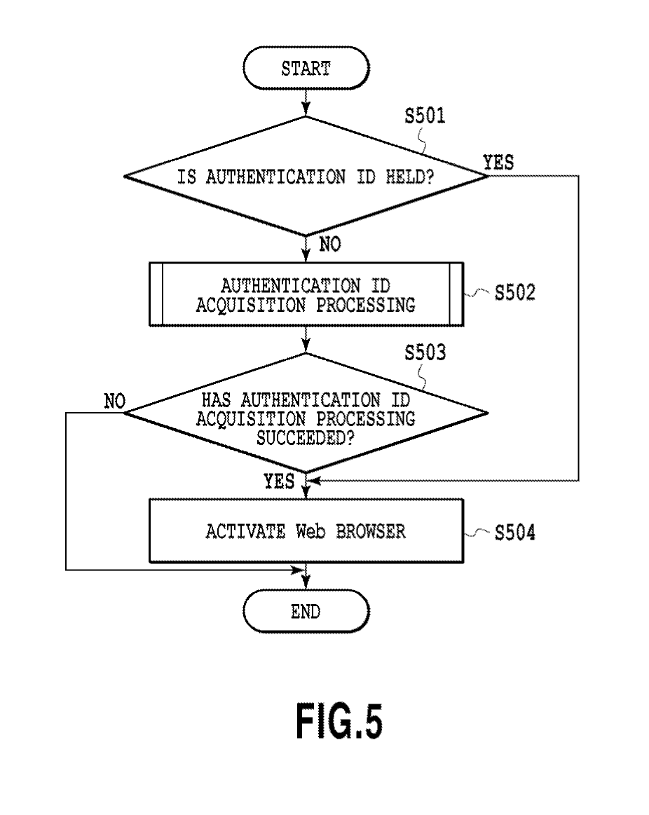

FIG. 4 is a diagram showing an example of a menu screen displayed on the display unit 108 of the MFPs 100/150. A menu screen 400 includes a Copy button 401 to start copying of a document, a Scan button 402 to start scanning of a document, and a Cloud button 403 to start utilization of a Web service. By a user pressing down the Cloud button 403, it is possible to utilize a service using the Web browser. Specifically, in the case where a user presses down the Cloud button 403, the MFPs 100/150 determine whether the authentication ID to utilize a Web service is already acquired by the MFPs 100/150. In the case where the authentication ID is acquired, the Web browser is activated. On the other hand, in the case where the authentication ID is not acquired, the Web browser is activated after the authentication ID is acquired. Details of the processing are explained using FIG. 5.

FIG. 5 is a flowchart showing a flow of processing to activate the Web browser performed in accordance with pressing-down of the Cloud button 403. The series of processing is implemented by the CPU 105 included in the MFPs 100/150 developing programs recorded in the program memory 106 on the work memory 107 and executing the programs.

At step 501, the MFPs 100/150 (hereinafter, MFP) determine presence/absence of the authentication ID for the Web service. Specifically, the MFP determines whether the authentication ID is held in the work memory 107 etc. Here, the authentication ID is information for identifying each MFP as a peripheral device on the Web service and information for proving that a peripheral device that accesses the server device 320 that is a Web server (hereinafter, Web server) is an authenticated device. Further, the authentication ID is also information necessary for a peripheral device to provide the Web service via the Web server and used in common also in the case where a plurality of Web servers exists. By the authentication processing using the authentication ID, it is made possible to prevent an illegal access, such as identity fraud. In the case where the presence of the authentication ID is determined, the procedure proceeds to step 504. On the other hand, in the case where the absence of the authentication ID is determined, the procedure proceeds to step 502.

At step 502, the MFP performs acquisition processing of the authentication ID using the client application 115. Here, the built-in UI is displayed on the display unit 108.

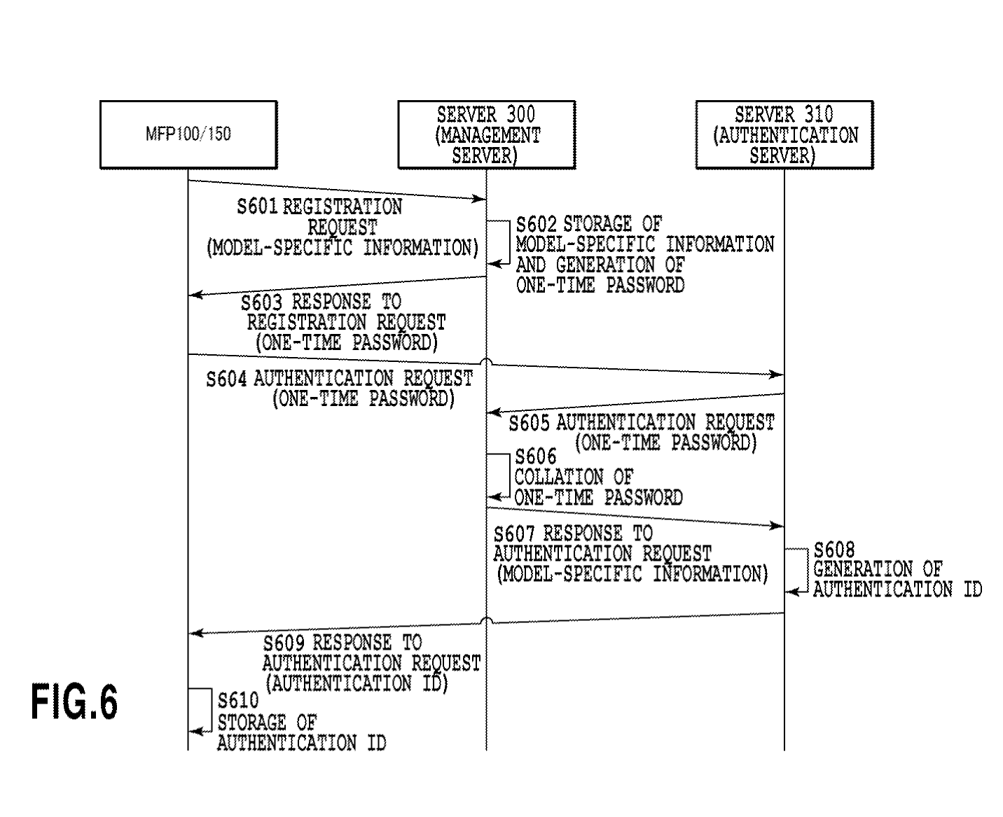

FIG. 6 is a sequence chart showing details of the authentication ID acquisition processing. At step 502 in FIG. 5, the processing of the MFPs 100/150 in the sequence chart explained in FIG. 6 is performed.

At step 601, the MFP makes a request for registration (registration request) to the server 300 that is the management server (hereinafter, management server) and at the same time, notifies the management server of model-specific information for specifying the MFP. Here, the model-specific information is, for example, a serial number that can identify the MFP uniquely, a MAC address, etc., and stored in advance in the program memory 106 etc.

At step 602, the management server generates a one-time password based on the received model-specific information. Here, the one-time password is a password with the term of validity used to provisionally identify the MFP. The model-specific information and the one-time password are associated with each other and stored in the HDD 202 of the management server.

At step 603, the management server makes a response to the registration request from the MFP and transmits the generated one-time password to the MFP.

At step 604, upon receipt of the one-time password from the management server, the MFP makes a request for authentication (authentication request) to the server device 310 that is an authentication server (hereinafter, authentication server) and at the same time, transmits the received one-time password to the authentication server.

At step 605, the authentication server makes an authentication request to the management server in response to the authentication request from the MFP and at the same time, transmits the received one-time password to the management server.

At step 606, the management server collates the one-time password stored at step 602 with the received one-time password in response to the authentication request from the authentication server and checks that both agree with each other.

After the collation of the one-time password is completed, at step 607, the management server makes a response to the authentication request from the authentication server. Specifically, the management server transmits the model-specific information associated with the received one-time password to the authentication server. After the transmission, the management server deletes the model-specific information stored at step 602 and the one-time password associated therewith from the HDD 202.

At step 608, the authentication server generates the above-described authentication ID based on the model-specific information received from the management server. The generated authentication ID is associated with the model-specific information of the MFP that has made the registration request and stored in the HDD 202 of the authentication server.

At step 609, the authentication server makes a response to the authentication request from the MFP. Specifically, the authentication server transmits the authentication ID generated and stored at step 608 to the MFP.

At step 610, the MFP stores the authentication ID received from the authentication server in the work memory 107 etc.

The above is the flow of the authentication ID acquisition processing.

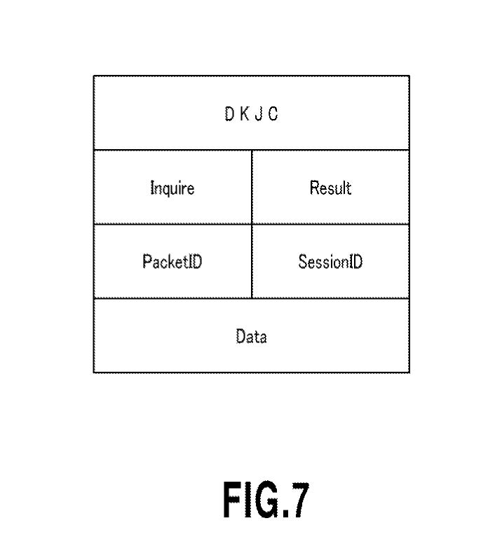

It may also be possible to repeat part or the whole of steps 601 to 609 a plurality of times and in such a case, securer acquisition processing will result. In the present embodiment, it is assumed that each piece of the processing at step 601, step 603, step 604, and step 609 is performed by a communication method with a higher level of security, for example, by a stateful and original communication protocol, using applications specialized in registration and authentication, respectively. For example, the registration request at step 601 is made by the TCP by encrypting a packet in the original format as shown in FIG. 7. By performing the authentication processing until the MFP stores the authentication ID by the stateful and original communication protocol using the client application specialized in the authentication processing as described above, it is possible to securely perform communication to sequentially control the peripheral device without an input of a user. It may also be possible to perform the authentication ID acquisition processing using the TLS-encrypted XMPP in place of the TCP.

Then, during the period from the time of making the registration request until the acquisition and storage of authentication ID, a message screen (not shown) indicating that communication is being performed is displayed on the display unit 108 of the MFP, thereby rejecting other jobs. As described above, by using the original format, the original encryption, the original port number, the original sequence, etc., in place of general-purpose ones, or by using an original authentication system configured by combining these, it is possible to construct a system with a higher level of security.

Further, it is also possible to reduce the running cost while maintaining a high level of security by using a certificate issued from a certification unit of its own as each certificate for authentication and by enabling arbitrary setting of the term of validity of the certificate.

Explanation is returned to the flowchart in FIG. 5.

At step 503, the MFP determines whether the authentication ID acquisition processing has succeeded by the processing explained in FIG. 6. In the case where the authentication ID acquisition processing has succeeded, the procedure proceeds to step 504. On the other hand, in the case where the authentication ID acquisition processing has failed, the present processing is exited.

At step 504, the MFP activates the Web browser, accesses the home address of the Web server, and makes a request for the home screen to utilize the Web service. At this time, the authentication ID acquired by the above-described authentication ID acquisition processing is also notified to the Web server.

Here, the display of the display unit 108 changes from the built-in UI to the browser UI, however, at this time, switching the UIs is automatically performed even in the case where a user does not give instructions to switch the UIs. In other words, at step 502 (FIG. 6) described above, the MFPs 100/150 perform communication with the server 300 and the server 310 by the original communication method with a high level of security in order to acquire the authentication ID. Then, in the case where the authentication ID is acquired, the MFPs 100/150 utilize the Web service by performing general-purpose communication using a protocol, for example, such as the HTTP, by the Web browser. Details of the Web service will be described later.

Next, the processing in the Web server to which the request for the home screen of the Web service is made from the MFP is explained.

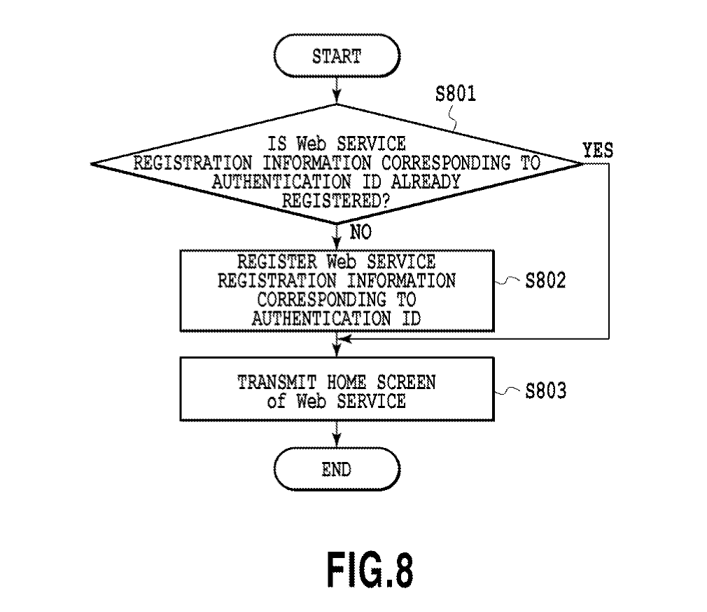

FIG. 8 is a flowchart showing a flow of processing in the Web server. The series of processing is implemented by the CPU 201 developing programs recorded in the HDD 202 on the memory 204 and executing the programs.

At step 801, the Web server determines whether the Web service registration information corresponding to the authentication ID, which is received together with the request for the Web service home screen, is already registered. Here, the Web service registration information is information necessary for providing the Web service via the Web server to a peripheral device (user) and includes, for example, the user ID, the use permission information, the time zone, the mail address, the used language, etc., and is managed for each Web service. In the case where the Web service registration information is not registered yet, the procedure proceeds to step 802. On the other hand, in the case where the Web service registration information is already registered, the procedure proceeds to step 803.

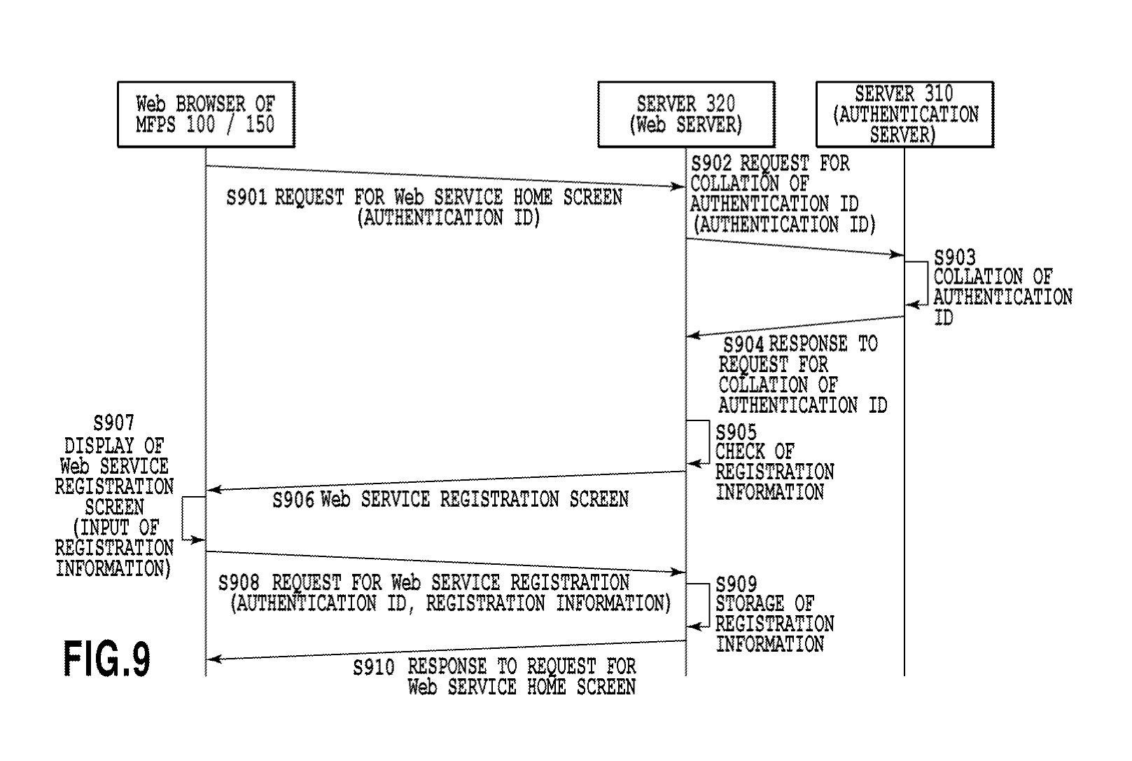

At step 802, the Web server performs processing to register the above-described Web service registration information corresponding to the authentication ID received from the MFP. Details of the processing to register the Web service registration information will be described in the explanation of a sequence chart (FIG. 9), to be described later.

At step 804, the Web server transmits the home screen of the Web service according to the request to the MFP.

The processing as described above is performed in the Web server in response to the request for the home screen of the Web service.

FIG. 9 is a sequence chart showing details from the time of making a request to utilize a Web service until the state where the Web service is available is brought about according to the present embodiment.

At step 901, the MFP accesses the home address of the Web server by the Web browser and makes a request for the home screen of the Web service and at the same time, transmits the authentication ID acquired by the authentication ID acquisition processing described previously to the Web server.

At step 902, upon receipt of the request for the Web service home screen from the MFP, the Web server makes a request for collation of the authentication ID to the authentication server having issued the authentication ID. Then, the Web server transmits the authentication ID received from the MFP to the authentication server together with the request for collation of the authentication ID.

At step 903, the authentication server checks whether the received authentication ID is an authorized ID. Specifically, the authentication server checks whether the authentication ID is an authorized ID by collating the received authentication ID with the authentication ID generated and stored at step 608 in the sequence chart in FIG. 6 described previously.

At step 904, the authentication server returns the result of collation to the Web server.

In the case where the authentication ID is an authorized ID, the Web server checks whether the Web service registration information corresponding to the authentication ID exists already (whether registered already) at step 905.

In the case where the Web service registration information is not registered yet, the Web server transmits a screen on which to register the Web service registration information (Web service registration screen) to the MFP at step 906.

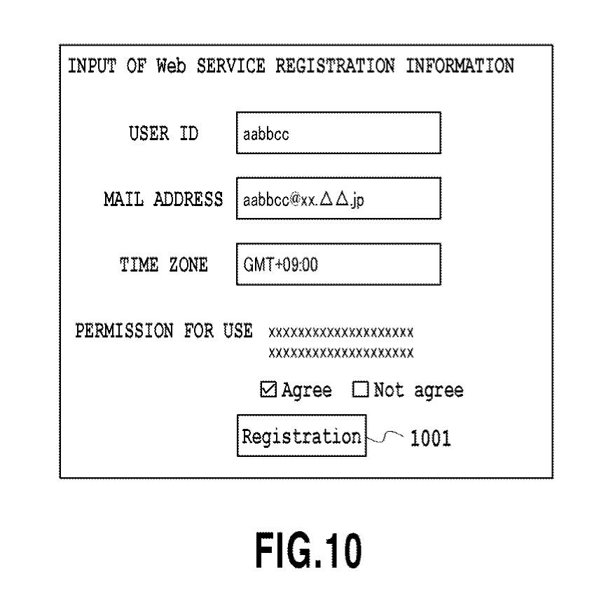

At step 907, the MFP displays the received Web service registration screen on the Web server. The user inputs necessary information to the displayed Web service registration screen. FIG. 10 is a diagram showing an example of the Web service registration screen and after inputting necessary information, the user presses down a Registration button 1001.

After the Registration button 1001 is pressed down by the user, the MFP makes a request for registration of the Web service to the Web server by the Web browser at step 908. In other words, the MFP transmits information input to the Web service registration screen to the Web server together with the authentication ID.

At step 909, the Web server stores and registers the received information in the HDD 202 as Web service registration information.

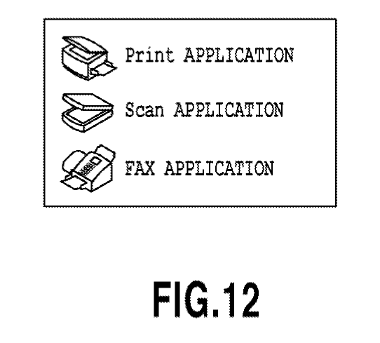

At step 910, the Web server transmits (returns) the Web service home screen to the MFP. FIG. 12 is a diagram showing an example of the Web service home screen provided by the server device 320 and the Web service home screen includes three kinds of Web services, i.e., Print application, Scan application, and FAX application. For example, in the case of Print application, it is possible for the user to acquire image data saved in a computer on a cloud and to perform printing by the MFPs 100/150.

After the Web service home screen transmitted from the Web server is displayed on the Web browser of the MFPs 100/150, it is made possible for the user to utilize the above-described Web service.

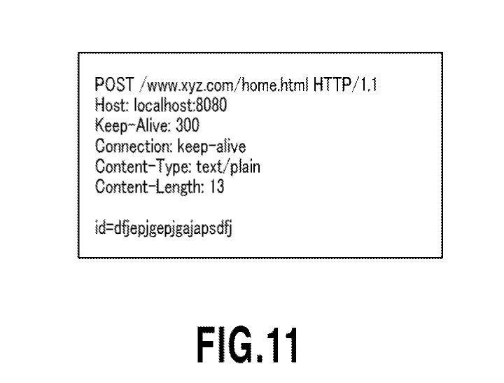

Here, it is desirable to perform each piece of processing at step 901, step 906, step 908, and step 910 described above by a communication method, such as the HTTP and HTTPS. For example, it is recommended to make the request for the Web service home screen at step 901 by the POST method of the HTTP as in FIG. 11. Then, a screen (not shown) of the Web browser is caused to be displayed on the display unit 108 of the MFP, by which it is possible to know how each piece of processing (step 901 to step 910) after the request for the Web service home screen is progressing.

By performing the processing until the Web service registration information is registered by the HTTP or HTTPS communication using the Web browser as described above, it is possible to cope with the change etc. of the Web service by updating the server without the need to change the firmware of the MFP, such as the update thereof. Due to this, the operability of a user is improved and at the same time, the running cost can be reduced.

In the present embodiment, the one-time password is used, however, it may also be possible to generate an authentication ID by storing in advance, for example, model-specific information of a peripheral device in the server and by collating the model-specific information received from the peripheral device with the model-specific information stored in advance in the management server.

Further, in the present embodiment, the model-specific information is transmitted from the peripheral device to the management server, however, in the case of the Web server that does not depend on the model of the peripheral device, the transmission of the model-specific information to the management server may be omitted.

By controlling and managing the network system by the technique described above, even in the case where the Web service registration information, such as the contents of permission for use, needs to be changed, it is only required to change the data of the Web service registration information registered in the Web server.

Further, even in the case where a new item needs to be added to the Web service registration information, it is only required to make a necessary modification in the Web server and to delete the Web service registration information corresponding to the authentication ID. At this time, in the case where a user intends to utilize the Web service, the authentication ID acquisition processing is skipped and it is only required to register the Web service registration information again from the Web browser.

In the present embodiment, at the time of acquisition of the authentication ID using the model-specific information etc., the MFPs 100/150 perform communication with the server 300 and the server 310 by the original communication method with a high level of security at step 502 (FIG. 6) described above. Then, in the case where the authentication ID is acquired, the MFPs 100/150 utilize the Web service by performing general-purpose communication using a protocol, for example, such as the HTTP, by the Web browser.

Consequently, according to the present embodiment, it is possible to prevent the model-specific information and one-time password from being leaked to a third person and at the same time, it is possible to appropriately and easily cope with various changes, addition of services, etc., in the Web server.

### Second Embodiment

Next, an aspect is explained as a second embodiment, in which a server device 330 that provides a new Web service is added newly to a client-server network system with the configuration shown in FIG. 1. Explanation of the portions in common to those in the first embodiment is omitted or simplified and different points are explained mainly.

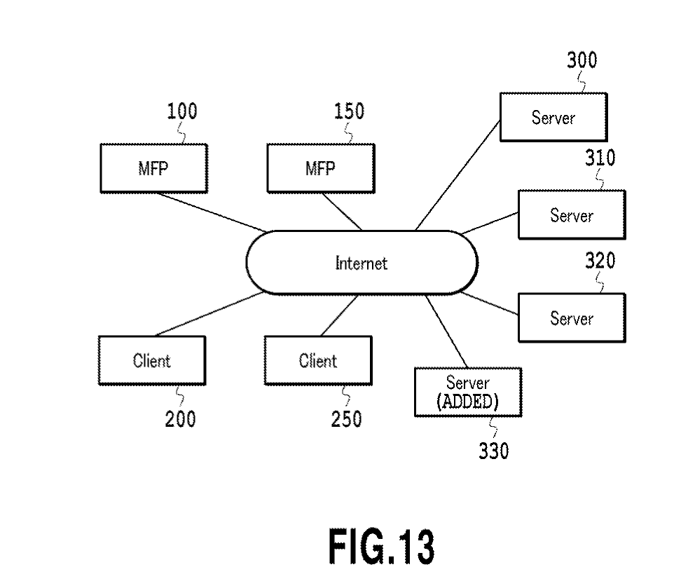

FIG. 13 is a block diagram showing an outline of a configuration of a client-server network system according to the present embodiment. As a Web server that provides a Web service (hereinafter, referred to as a “Web service B”) different from the Web service provided by the server device 320 (hereinafter, referred to as a “Web service A”), the server device 330 is added. In the case where a new Web server is added to an already existing network system as described above, in the originally existing Web server, information of the new Web server is held in association with the new Web service (here, Web service B).

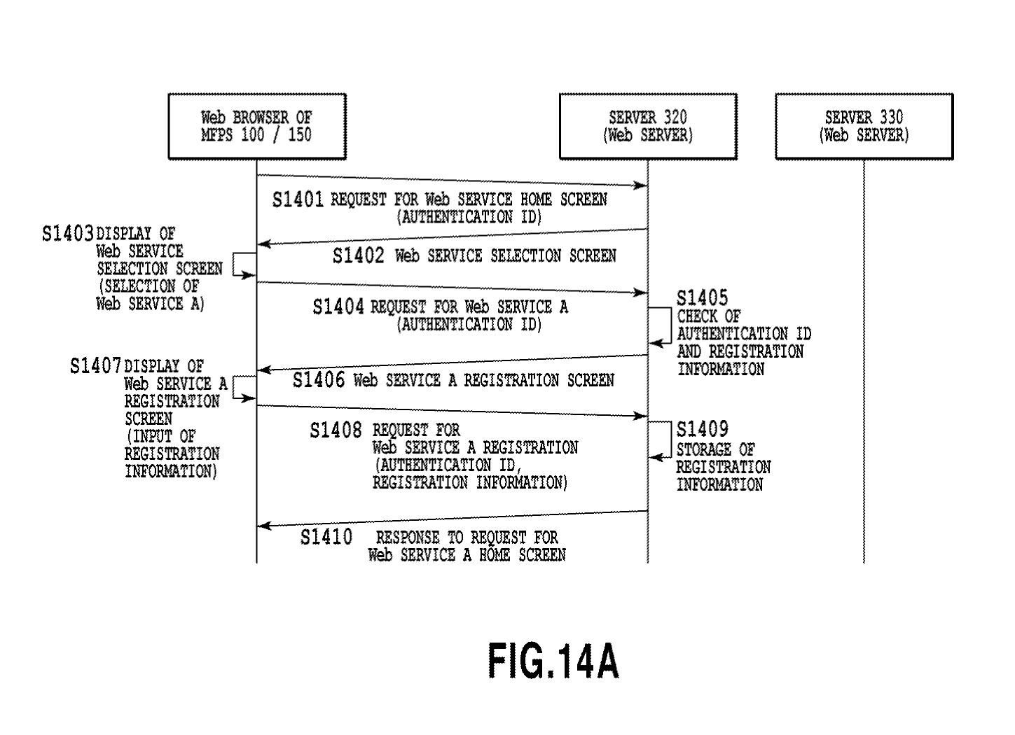

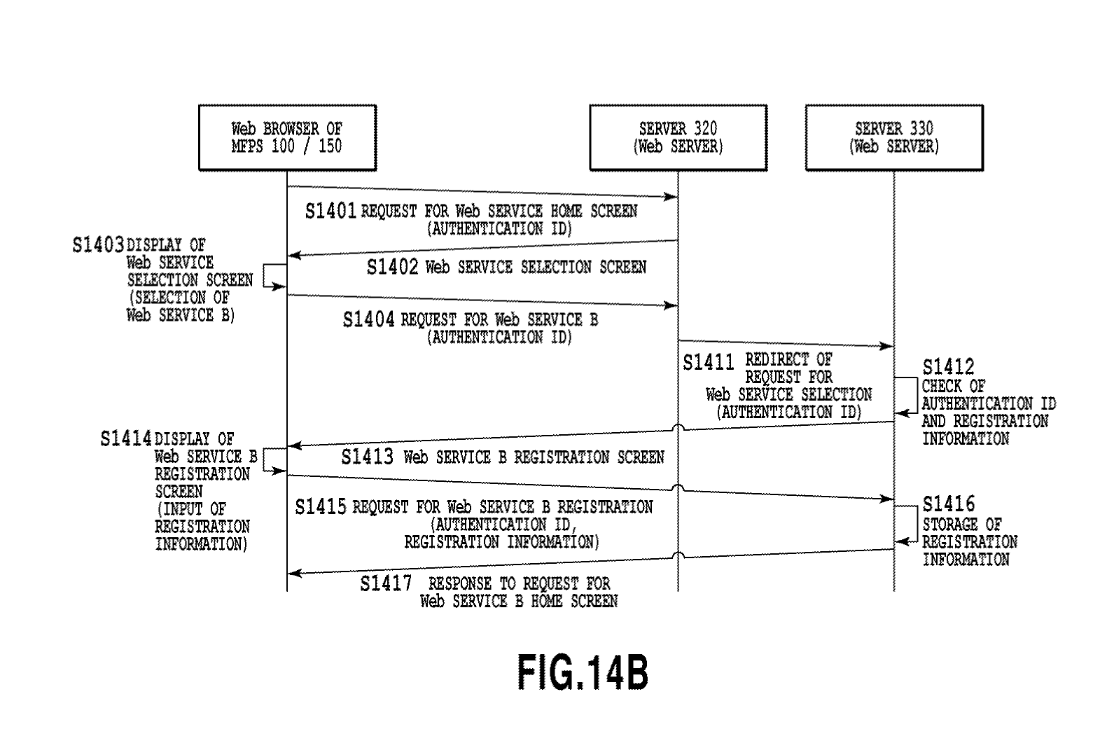

FIGS. 14A and 14B are each a sequence chart showing details from the time of making a request for a Web service from the MFP until the state where the Web service is available is brought about, corresponding to the sequence chart in FIG. 9 of the first embodiment.

First, FIG. 14A is explained, which shows a flow of the processing in the case where a user utilizes the Web service A provided by the already existing Web server (server device 320).

At step 1401, the MFP accesses the home address of the Web service by the Web browser and makes a request for the Web service home screen to the already existing server device 320 and at the same time, notifies the server device 320 of the authentication ID. As described above, in the present embodiment, the access destination at the time of utilizing the Web service does not change also after the Web server that provides the new Web service is added. In other words, it is possible for a user to always access the already existing Web server.

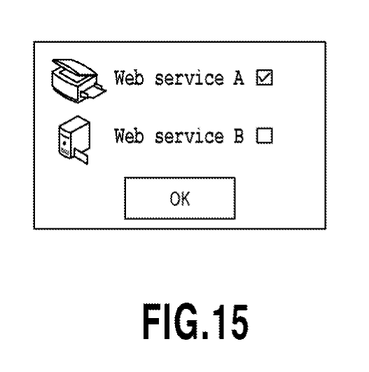

At step 1402, the server device 320 generates a screen on which to select a Web service that is utilized (Web service selection screen) and transmits the screen to the MFP. FIG. 15 is a diagram showing an example of the Web service selection screen and by checking the checkbox of the Web service the user desires to utilize and pressing down an OK button, the Web service is selected. It is needless to say that the contents of the Web service selection screen are updated each time the system configuration is changed, such as addition of a new Web server.

At step 1403, the MFP displays the Web service selection screen received from the server device 320 on the Web browser. The user selects a Web service (here, the Web service A) the user desires to utilize in the displayed Web service selection screen.

After the selection of the Web service A by the user, at step 1404, the MFP makes a request for the Web service A to the server device 320 by the Web browser and at the same time, transmits the authentication ID to the server device 320.

At step 1405, the server device 320 checks the received authentication ID and the Web service registration information corresponding thereto. In other words, the processing at step 902 to step 905 in the sequence chart in FIG. 9 described previously is performed. Details of each piece of the processing are already described in the first embodiment, and therefore, explanation is omitted here.

In the case where the authentication ID is an authorized ID and the Web service registration information corresponding to the authentication ID is not registered yet, at step 1406, the server device 320 transmits a screen on which to register the registration information of the Web service A (Web service A registration screen) to the MFP.

At step 1407, the MFP displays the received Web service A registration screen on the Web browser. The user inputs necessary information to the displayed Web service A registration screen and presses down the Registration button 1001.

After the Registration button 1001 is pressed down by the user, at step 1408, the MFP makes a request for registration of the Web service A to the server device 320 by the Web browser. In other words, the information input to the Web service A registration screen is transmitted to the server device 320 together with the authentication ID.

At step 1409, the server device 320 stores and registers the received information in the HDD 202 as the Web service A registration information.

At step 1410, the server device 320 transmits (returns) the home screen of the Web service A to the MFP. Then, after the Web service A home screen transmitted from the server device 320 is displayed on the Web browser of the MFPs 100/150, it is made possible for the user to utilize the Web service A.

Next, FIG. 14B is explained, which shows a flow of processing in the case where a user utilizes the Web service B provided by the newly added Web server (server device 330).

Step 1401 to step 1404 are the same as those explained in FIG. 14A except in that the Web service B provided by the server device 330 is selected. In other words, even in the case where the user desires to utilize the Web service B, it is only required for the user to access the server device 320, which is the already existing server, as described above.

The server device 320 having received a request for the Web service B redirects the request to the server device 330 together with the authentication ID at step 1411.

At step 1412, the server device 330 checks the authentication ID and the Web service registration information as at step 1405 described previously.

In the case where the authentication ID is an authorized ID and the Web service registration information corresponding to the authentication ID is not registered yet, at step 1413, the server device 330 transmits a screen on which to register the registration information of the Web service B (Web service B registration screen) to the MFP.

At step 1414, the MFP displays the received Web service B registration screen on the Web browser. The user inputs necessary information to the displayed Web service B registration screen and presses down the Registration button 1001.

After the Registration button 1001 is pressed down by the user, at step 1415, the MFP makes a request for registration of the Web service B to the server device 330. In other words, the information input to the Web service B registration screen is transmitted to the server device 330 together with the authentication ID.

At step 1416, the server device 330 stores and registers the received information in the HDD 202 as the Web service B registration information.

At step 1417, the server device 330 transmits (returns) the home screen of the Web service B to the MFP. Then, after the Web service B home screen transmitted from the server device 330 is displayed on the Web browser of the MFPs 100/150, it is made possible for the user to utilize the Web service B.

As described above, according to the present embodiment, even in the case where the Web server that provides a new Web service is added, it is possible to cope with the case by only the update on the Web server side without the need to change the firmware of a peripheral device, such as the update thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-135013, filed Jun. 27, 2013, which is hereby incorporated by reference herein in its entirety.

What is claimed is:

1. A communication method between a device including a Web browser and a server, the communication method comprising the steps of:
acquiring, by the device, an authentication ID to utilize a Web service by the Web browser from an authentication server by a first communication method that does not use the Web browser; and
communicating, by the device, with a Web server that provides the Web service using the authentication ID acquired in the acquisition step by a second communication method that uses the Web browser.

2. The communication method according to claim 1, wherein
the first communication method is communication using a predetermined communication method on the TCP or XMPP by an application for acquiring the authentication ID, and
the second communication method is communication using the HTTP or HTTPS by the Web browser.

3. The communication method according to claim 1, wherein
the acquisition step includes the steps of:
acquiring, by the device, a one-time password from an information processing apparatus as a management server;
making, by the device, a request for authentication ID to the authentication server using the acquired one-time password;
making, by the authentication server having received the request for authentication ID, a request for collation of the one-time password to the management server; and
generating, by the authentication server having received the request for authentication ID, an authentication ID for the device in response to the result of the collation.

4. The communication method according to claim 1, wherein
the device communicates with one or more information processing apparatuses that also function as the Web server and the authentication server.

5. The communication method according to claim 1 comprising the step of:
displaying, by the device, a first screen on which for a user to specify the Web service on a display screen, wherein
the authentication ID is acquired by the first communication method in accordance with instructions of the user given to the first screen.

6. The communication method according to claim 5, wherein
the authentication ID is acquired by the first communication method in a case where the authentication ID is not acquired yet at the time of giving instructions by the user to the first screen.

7. The communication method according to claim 5, wherein
the first screen can be displayed without using the Web browser, and
a second screen related to the Web service is displayed by the Web browser in response to acquisition of the authentication ID by instructions of the user to the first screen even in a case where no instructions are given to the Web browser by the user.

8. A device including a Web browser and capable of communicating with a server, the device comprising:
an acquisition unit configured to acquire an authentication ID to utilize a Web service by the Web browser from an authentication server by a first communication method that does not use the Web browser; and
a communication unit configured to communicate with a Web server to utilize the Web service using the authentication ID acquired by the acquisition unit by a second communication method that uses the Web browser.

9. The device according to claim 8, wherein
the first communication method is communication using a predetermined communication method on the TCP or XMPP by an application for acquiring the authentication ID, and
the second communication method is communication using the HTTP or HTTPS by the Web browser.

10. The device according to claim 8 comprising;
a first display control unit configured to display a first screen on which for a user to specify the Web service on a display screen, wherein
the acquisition unit acquires the authentication ID by the first communication method in response to instructions of the user to the first screen displayed by the first display control unit.

11. The device according to claim 10, wherein
the acquisition unit acquires the authentication ID by the first communication method in a case where the authentication ID is not acquired yet at the time of giving instructions by the user to the first screen displayed by the first display control unit.

12. The device according to claim 10 comprising:
a second display control unit configured to cause the Web browser to display a second screen related to the Web service, wherein
the first display control unit is capable of displaying the first screen without using the Web browser, and
the second display control unit causes the Web browser to display a second screen related to the Web service in response to acquisition of the authentication ID by instructions of the user to the first screen even in a case where no instructions are given to the Web browser by the user.

13. The device according to claim 8, wherein
the device is a printer, a scanner, a camera, a PC, or a mobile phone.

14. An information processing apparatus that communicates with a device including a Web browser, the information processing apparatus comprising:
a supply unit configured to supply an authentication ID for the device to utilize a Web service by the Web browser to the device by a first communication method in which the device does not use the Web browser; and
a communication unit configured to communicate with the device in order to provide the Web service to the device using the authentication ID by a second communication method in which the device uses the Web browser.

15. The information processing apparatus according to claim 14, wherein
the first communication method is communication using a predetermined communication method on the TCP or XMPP, and
the second communication method is communication using the HTTP or HTTPS.

16. A non-transitory computer readable storage medium storing a program for causing a computer to perform the communication method according to claim 1.
